(19) United States
(12) Patent Application Publication
(10) Pub. No.: US 2021/0180274 A1
(43) Pub. Date: Jun. 17, 2021

(54) PAVEMENT MARKINGS AND PAVEMENT MARKING SYSTEM FOR LANE IDENTIFICATION

(71) Applicant: 3M INNOVATIVE PROPERTIES COMPANY, St. Paul, MN (US)

(72) Inventors: Susannah C. Clear, Hastings, MN (US); Thomas P. Hedblom, Eagan, MN (US); Kenton D. Budd, Woodbury, MN (US)

(21) Appl. No.: 16/771,073

(22) PCT Filed: Dec. 6, 2018
(86) PCT No.: PCT/IB2018/059724

§ 371 Date: Jun. 9, 2020

Related U.S. Application Data
(60) Provisional application No. 62/598,500, filed on Dec. 14, 2017.

(51) Int. Cl. E01F 9/524; E01F 9/30; E01F 9/512; E01F 9/576; B32B 3/30; B32B 7/12; B32B 7/023; B32B 5/16; B32B 27/40; G01S 17/88

(52) U.S. Cl. CPC E01F 9/524; E01F 9/30; E01F 9/512; E01F 9/578; B32B 3/30; B32B 7/12; B32B 2307/416; B32B 5/16; B32B 27/40; G01S 17/88; B32B 2264/101; B32B 2264/107; B32B 7/023

(57) ABSTRACT

In one aspect, the present application relates to dark-colored retroreflective pavement markings. The dark-colored retroreflective pavement markings may be used in a system that provides information about the arrangement of pavement markings to a sensor on a vehicle. This arrangement may be used to aid in the identification of a particular lane on a roadway. The pavement marking system comprises a sensor placed on a vehicle and at least a first pavement marking and a second pavement marking, wherein each of the first pavement marking a second pavement marking comprising different properties

### TECHNICAL FIELD

The present disclosure relates to dark-colored retroreflective pavement markings and a pavement marking system for lane identification comprising dark-colored retroreflective pavement markings.

### BACKGROUND

Pavement or road markings (e.g., paints, tapes, and individually mounted articles) guide and direct motorists and pedestrians traveling along roadways and paths. Pavement or road markings can be used on, for example, roads, highways, parking lots, and recreational trails. Typically, pavement markings form stripes, bars, and markings for the delineation of lanes, crosswalks, parking spaces, symbols, legends, and the like.

Paint was a preferred pavement marking for many years. Retroreflective liquid pavement markings typically include retroreflective elements. Retroreflective liquid pavement markings offer significant advantages over paint, such as increased visibility, retroreflectivity, improved durability, and temporary and/or removable marking options. Such retroreflective elements are described in, for example, U.S. Pat. Nos. 5,750,191; 5,774,265; 5,942,280; 7,513,941; 8,591,044; 8,591,045; and U.S. Patent Publication Nos. 2005/0100709 and 2005/0158461, all of which are incorporated herein in their entireties. Commercially available retroreflective elements include, for example, 3M™ All Weather Elements made by 3M Company of St. Paul, Minn. Typically, a retroreflective element includes a core adjacent to numerous glass or glass ceramic beads that are adhered to the outermost surface of core by a binder.

Retroreflective tapes incorporate retroreflective beads durably adhered to a flexible substrate, which in turn is adhered to the roadway to delineate features on the surface such as lanes. Such retroreflective tapes are described in, for example, U.S. Pat. No. 5,777,791, which is incorporated herein in its entirety. Commercially available pavement marking tapes include, for example, 3M™ Stamark™ High Performance Tape 3801 ES and 3M™ Stamark™ All Weather Tape 380AW.

Typically, pavement markings need to be visibly apparent in both daytime and nighttime driving conditions. At nighttime when the roadway in front of the vehicle is illuminated primarily by headlamps, the retroreflectivity of the marking is critically important to the visibility of the marking. In the daytime, however, illumination is primarily scattered diffuse ambient. Under these conditions, luminance or contrast of the marking relative to the surrounding roadway substrate is critical to detection of the marking and differentiation from the substrate. In conventional automobiles, visible detection of the pavement marking by the human driver is necessary.

In some cases, pavement markings are more easily detected by human drivers and/or advanced vehicle systems (AVS) (e.g., machine vision systems, systems using LiDAR) when there is sufficient contrast between the underlying surface to which they are applied and the pavement marking. For example, a white pavement marking applied on a concrete road may not have enough contrast to enable detection.

Advanced vehicle systems can use various technologies to receive information. One common advanced vehicle system includes a camera to receive information through machine vision. These machine vision systems can function over a range of wavelengths that extend beyond the visible light spectrum. For example, it is possible for machine vision systems to function in the infrared or near-infrared spectrum. By doing this, the machine vision system can identify features that are not visible (e.g., are transparent) to the human eye.

In addition, sensors on vehicles can be made to detect the absence or presence of a pavement marking and its location relative to a vehicle and to the trajectory of a vehicle. These data serve as inputs to advanced driver assistance systems (ADAS) such as lane departure warning systems and lane keeping systems, as well as autonomous driving systems or autopilot functions. In a lane departure warning system, the driver is alerted if the vehicle begins to cross or crosses the pavement markings. In a lane keeping system, the lane detection function serves to trigger the engagement of the steering system of the vehicle to return the vehicle to the lane. In autonomous driving or autopilot systems, detecting the pavement markings is key to keeping the vehicle in the lane and to calculating the future path of the vehicle. Such systems commonly rely on forward-facing cameras that have a fairly narrow field-of-view, particularly if they are designed for autonomous driving. As a result of this narrow field-of-view, not all of the lanes of traffic may be visible in the field-of-view of the camera when travelling on multilane roadways, and lane markings designed for human vision do not typically explicitly distinguish one lane from another. Lane markings that explicitly tag lanes should convey this information at all points in the lane marking so as to minimize occlusion by passing vehicles and other obstacles in the roadway. Additionally, lane markings that explicitly tag lanes should do so in a computationally inexpensive manner to minimize computing load on the vehicle computers, and in a manner that is robustly detectable over a wide range of lighting conditions, weather conditions (e.g. dry and wet), and pavement substrates. Lastly, lane markings that explicitly tag lanes should minimize complexity of installation to mitigate potential erroneous labeling.

A black pavement marking may provide better contrast to concrete roads or adjacent light-colored pavement markings (e.g., white pavement markings) and increase detection by machine vision systems and human drivers. One previous attempt to produce a black pavement marking include using a black backing, such as, for example, a black rubber backing. A second attempt, as described in PCT Publication No. WO 99/04096 (Hedblom et al.), details black pavement markings comprising retroreflective elements embedded in a binder layer. The binder layer is comprised of a binder material, black pigment (e.g., carbon black), light-reflecting system, optical elements and optional skid-resistant particles. The light-reflecting system may comprise either a specular pigment such as a pearlescent pigment or a diffuse pigment. The black pigment is preferably carbon black with a particle size ranging from 0.01 micron to about 0.08 micron. Generally, the black pigment is added at about 1 weight percent or greater and the ratio of the light-reflecting system to the black pigment ranges from about 7:1 to about 80:1 by weight.

### SUMMARY

Previous attempts to produce a dark-colored pavement marking have resulted in at least one of (i) insufficient retroreflectivity of the black pavement marking; (ii) inadequate color (e.g., pavement marking was not dark/black enough); and (iii) required use of a multicomponent system to provide color and to enable retroreflection. In the black pavement marking of WO 99/04096 (Hedblom et al.), for example, the multicomponent system comprised at least a black pigment to impart color and a light-reflecting system to enable retroreflection.

In one aspect, the present application relates to retroreflective pavement markings that appear dark (e.g., black) in the visible spectrum while having adequate retroreflectivity in the visible and near-infrared spectra. In another aspect, the dark-colored retroreflective pavement markings are produced with fewer materials. In one aspect, the dark-colored retroreflective pavement markings include an infrared-reflecting pigment that imparts color in the visible spectrum and enables retroreflection.

In one aspect, dark-colored retroreflective pavement markings can be made inconspicuous to a human driver in daytime conditions (i.e., under diffuse lighting conditions) by having it applied to a substrate of similar color, such as, for example, asphalt. As a result, the human eye is unable to detect or resolve contrast between the dark-colored retroreflective pavement marking and the underlying substrate under daytime conditions. However, due to its retroreflectivity, the dark-colored retroreflective pavement markings are readily detectable by both human driver and machine vision system under retroreflective conditions.

Alternatively, the dark-colored retroreflective pavement markings may be placed on light-colored substrates (e.g., concrete) or adjacent light-colored pavement markings (e.g., white pavement markings), resulting in improved contrast between the dark-colored pavement marking and light-colored surroundings.

Also disclosed is a pavement marking system that provides information to advanced vehicle systems, such as autonomous vehicles, and advanced driver assistance systems (ADAS).

In one embodiment, the dark-colored pavement marking comprises: a binder layer; an infrared-reflecting black pigment; and a plurality of retroreflective elements distributed on at least a portion of the binder layer. In one embodiment, the binder layer is a polyurethane. In one embodiment, the pavement marking has a luminance factor Y of less than 10. In one embodiment, the dark-colored pavement marking has a Qd of less than 80 mcd·m-2·lx-1.

In another aspect, the present application relates to a pavement marking construction including a dark-colored retroreflective pavement marking comprising a binder layer including an infrared-reflecting pigment and optical elements; and a second pavement marking adjacent to the dark-colored retroreflective pavement marking; wherein the dark-colored retroreflective pavement marking has a first property and the second pavement marking has a second property; and wherein the second property is different from the first property. In one embodiment, the first property and the second property are one of color, wavelength, or retroreflectivity.

In yet another aspect, the present application relates to a pavement marking system comprising: a first pavement marking comprising a binder including a black infrared-reflecting pigment, wherein the first pavement marking has a first property; a second pavement marking comprising a binder having a second property, different from the first property, the second pavement marking being adjacent the first pavement marking; a sensor that detects a difference between the first property and the second property and generates a signal; and a processing unit that processes the signal and provides an output to a vehicle.

### BRIEF DESCRIPTION OF DRAWINGS

FIG. 1 shows a cross-section of a first exemplary dark-colored pavement marking.

FIG. 2 shows a cross-section of a second exemplary dark-colored pavement marking.

FIG. 3 shows a top view of an exemplary pavement marking system.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

In one aspect, the disclosed dark-colored retroreflective pavement markings appear dark (e.g., black) in the visible spectrum while having adequate retroreflectivity in both visible and near-infrared spectra. The dark-colored retroreflective pavement markings comprise at least a binder layer, an infrared-reflecting black pigment, and a plurality of retroreflective elements distributed on at least a portion of the binder layer.

In some embodiments, the dark-colored retroreflective pavement markings are inconspicuous to a sensor (e.g., camera or human driver) in ambient conditions (i.e., diffuse lighting), such as for example, when the dark-colored pavement markings are applied to a dark-colored substrate, such as, for example, asphalt. The human eye or machine vision sensor operating in the visible spectrum is unable to detect contrast between the dark-colored retroreflective pavement marking and the underlying dark-colored substrate under ambient conditions. Also, the human driver is usually trained to ignore black pavement markings as black is not generally used for lane guidance. However, because the dark-colored pavement markings are retroreflective in the visible and infrared spectra, the dark-colored pavement markings appear bright when viewed under retroreflective conditions (i.e., when a light beam is directed to the pavement marking). For human drivers, the dark-colored pavement markings are dark (e.g., black) under ambient conditions (i.e., diffuse lighting) but are bright and thus readily detectable under retroreflective conditions. Similarly, an infrared-sensitive sensor (e.g., infrared camera) readily detects the dark-colored pavement markings under retroreflective near infrared conditions.

As used herein, the terms “dark-colored” and “dark color” are used to describe pavement markings having a luminance factor (Y) of less than 15, as measured according to the procedure for a flat sample generally described in ASTM D6628-03, “Standard Specification for Color of Pavement Marking Materials”, with a 45°:0° illuminating and viewing geometry. In some embodiments, luminance factor Y of dark-colored retroreflective pavement markings is less than 10, less than 6.5, less than 6.0 or less than 5.5.

As used herein, the terms “infrared-reflecting pigment” or “near infrared-reflecting pigment” are used interchangeably and are meant to describe pigments that include a plurality of particles that have low absorbance (i.e., high transparency) of near infrared wavelengths (700-1500 nm) and high absorbance of visible wavelengths. As a result, infrared-reflecting pigments will cause most of impinging light in the near infrared spectrum to diffusely reflect, with small adsorption or transmission, whereas most of impinging light in the visible spectrum will be absorbed. As such, presently described dark-colored pavement markings comprising infrared-reflecting pigments provide diffuse reflectance of wavelengths in the near-infrared spectrum and high absorption of wavelengths in the visible spectrum. Such pavement markings appear dark in the visible spectrum.

Due to the diffuse reflection of near infrared wavelengths provided by the infrared-reflecting pigments, part of the impinging near infrared light is retroreflected (i.e., reflected in an oriented manner back to the light source), resulting in a bright signal detectable by infrared sensors (e.g., infrared cameras). It was surprisingly found by the present inventors that the herein described dark-colored retroreflective pavement markings also provide adequate retroreflection in the visible spectrum, despite the infrared-reflecting pigment absorbing most of the light in visible wavelengths. Without wishing to be bound by theory, it is believed that for retroreflection of articles including beads (e.g., beaded retroreflection), relevant light paths through the beads generally involve a single reflection at the rear bead surface, resulting in minimal adsorbed light by the pigment, compared with a multiple bounce diffuse scattering situation. It is believed that optimally sized black infrared reflecting pigments maximize this effect. In some embodiments, the black infrared reflecting pigments have a particle size of about 1 micron.

Black pavement markings including black pigments were described in, for example, PCT Publication No. WO 99/04096 (Hedblom, et. al.). The black pavement markings of Hedblom et. al. require a multicomponent system comprising at least a binder layer comprising a binder material, black pigment (e.g., carbon black), light-reflecting system, and optical elements. The black pigment has a particle size ranging from about 0.01 micron to about 0.08 micron. The light-reflecting system comprises a specular pigment (e.g., pearlescent pigment) or a diffuse pigment (e.g., titanium dioxide, zinc oxide, zinc sulfide). The compositions of Hedblom et al. rely on both a black pigment for color and a light reflection pigment for retroreflection. Because carbon black absorbs light in the visible and near infrared spectra, an increased amount of carbon black in pavement markings is needed to render it black (i.e., reduce Y). The increased amount of carbon black may negatively impact retroreflectivity as well as compromise mechanical properties of the pavement marking.

In contrast, the presently described dark-colored retroreflective pavement markings have low luminance factor Y even without addition of black absorbing pigments, such as carbon black. It also requires fewer components than the compositions of the prior art. Furthermore, the presently described dark-colored retroreflective pavement markings provide adequate retroreflectivity in both the visible and infrared spectra without requiring light-reflecting systems.

Retroreflectivity may be measured as the coefficient of retroreflected luminance, R_{L}, as generally described in ASTM E1710-11, “Standard Test Method for Measurement of Retroreflective Pavement Marking Materials with CEN-Prescribed Geometry Using a Portable Retroreflectometer”. By “adequate retroreflectivity”, it is generally meant that the retroreflected luminance (R_{L}) in the visible spectrum is at least 200 mcd/lux.m².

Without wishing to be bound by theory, it is believed dark-colored retroreflective pavement markings including infrared-reflecting pigment according to the present application have surprising retroreflectivity in the visible spectrum because the infrared-reflecting pigment has a large particle size (e.g., about 1 micron). One theory is that larger particles may be favorable to single bounce reflection that maintains a ray trace.

The dark-colored retroreflective pavement markings disclosed herein may be used in advanced vehicle systems (ADAS) such as in lane keeping and/or lane departure warning systems. In lane keeping, the goal is to automatically control the vehicle so that it stays in the current travel lane, whereas a lane departure warning system uses its lane estimates to assist the human driver and emits an audible or visible warning if there is an unexpected lane change.

In one embodiment, the dark-colored retroreflective pavement markings are useful in lane detection systems, by allowing a vehicle to not only detect the existence of a lane but also to identify the lane's position with respect to the roadway. In other words, the methods and systems described identify the lateral positioning (e.g., lane) of a roadway by sensing and extracting from the output of the sensor a signal that enables identification of the lane position. The basis for this extraction are differentiating features that correlate to spatial aspects of lanes in a road environment and that are extracted from information derived from output obtained from the sensor. Such sensor may be a camera for image capturing which is arranged somewhere on a vehicle (e.g., windshield, bumper, etc.) to sense the environment ahead of and/or around the vehicle.

While currently existing systems are generally successful in identifying the existence of lanes, the existing systems are unable to identify the position of the detected lane with respect to adjacent lanes travelling in the same direction of the vehicle or in opposite direction.

The dark-colored retroreflective pavement markings are retroreflective in a wide range of wavelengths, including, for example, in visible and near infrared wavelengths. However, under daytime conditions, the pavement markings have a dark color and/or matte appearance that is relatively unobtrusive to a human driver.

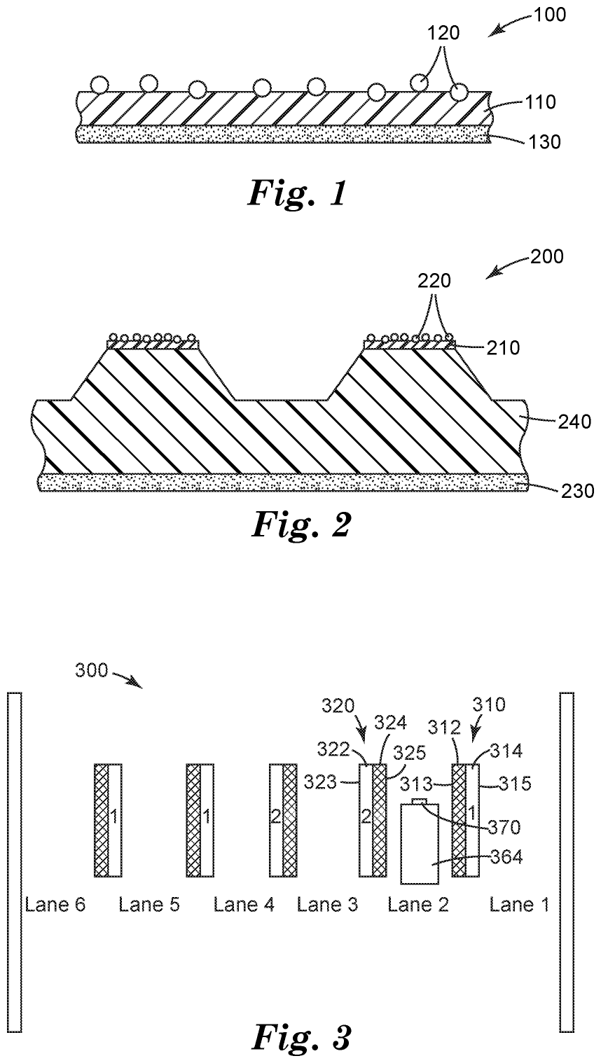

FIG. 1 shows a cross sectional view of an exemplary dark-colored retroreflective pavement marking 100. Dark-colored retroreflective pavement marking 100 includes a binder layer 110 and an infrared-reflecting pigment. Retroreflective elements 120 are distributed on a surface of the binder layer 110. In one embodiment, the infrared-reflecting pigment is distributed throughout the binder layer 110. Dark-colored retroreflective pavement marking 100 further includes optional adhesive layer 130 to bond the dark-colored pavement marking 100 to a substrate (not shown).

FIG. 2 shows a cross sectional view of a second embodiment of a dark-colored retroreflective pavement marking 200 comprising raised portions, and will be referred to hereinafter as an embossed structure. The dark-colored retroreflective pavement marking 200 comprises a binder layer 210 comprising an infrared-reflecting pigment and retroreflective elements 220 distributed on a surface of the binder layer 210. Dark-colored retroreflective pavement marking 200 further includes additional backing layer 240 and adhesive layer 230.

The binder layer 110, 210 typically comprises a polymeric material. Any number of know polymeric materials may be used for the binder layer(s) 110, 210 of dark-colored pavement markings 100, 200. Illustrative examples of suitable polymeric materials include thermoset materials and thermoplastic materials. Suitable polymeric material includes, but is not limited to, urethanes, epoxies, alkyds, acrylics, acid olefin copolymers such as ethylene/methacrylic acid and its ionomers, ethylene/acrylic acid, polyvinyl chloride/polyvinyl acetate copolymers, etc. In some embodiments, the binder layer is a nonporous binder layer.

The binder layer 110, 210 may be a reactive system capable of substantial crosslinking, including: two-part polyurethane, a polyurea, a glycidyl-substituted acrylic, or epoxy. The binder layer 100 may also be an extrudable polymer, including a substituted polyolefin or polyolefin copolymer, polyurethane, acrylic, or acrylic copolymer. The binder layer 110, 210 may also be a film formed from a film-forming latex or emulsion, including a polyurethane latex, acrylic latex or a styrenic elastomer emulsion.

In one embodiment, the dark-colored retroreflective pavement marking 100 includes a liquid binder 110. The liquid dark-colored retroreflective pavement marking is applied to the substrate (i.e., the roadway) followed by the addition of retroreflective elements 120 to the exposed surface of the binder 110 of the dark-colored retroreflective pavement marking 100.

In another embodiment, dark-colored retroreflective pavement marking 100 is a tape. Typically, when the dark-colored retroreflective pavement marking 100 is a tape, an additional backing (not shown) and/or adhesive layer 130 is included. The additional backing layer is typically positioned adjacent the binder 110 opposite from the surface containing the retroreflective elements 120.

In one embodiment, such as shown in FIG. 2, dark-colored retroreflective pavement marking 200 is a pre-formed embossed structure and includes backing layer 240. In some embodiments, backing layer 240 is an embossed rubber backing, such as disclosed in U.S. Patent Publication No. 2014/0011911, the disclosure of which is herein incorporated by reference in its entirety. In one embodiment, the material of the binder layer 210 itself secures the retroreflective elements 220 to the backing layer 240, such as disclosed in PCT Publication WO 2016/205443, the disclosure of which is herein incorporated by reference.

In one embodiment, the binder comprising the infrared-reflecting pigment is coated onto the top surfaces of the embossed features on an embossed pavement marking such as described in U.S. Pat. No. 4,988,541, the disclosure of which is herein incorporated by reference. In one such embossed embodiment, these coated surfaces may have a cumulative area percentage of 29% of the pavement marking, and the embossed features may have a square face 6.5 mm in length, are 1.9 mm above the base, are arranged in rows and columns, and may be spaced apart at a distance of 5.4 mm. This embodiment has a Qd, the luminance coefficient under diffuse illumination as defined by ASTM E2303 (discussed further below), of at less than 100 mcd·m-2·lx-1. In one embodiment, the disclosed dark-colored retroreflective pavement marking has a Qd of less than 80 mcd·m-2·lx-1.

In one embodiment, the dark-colored pavement marking 100, 200 further comprises an adhesive 130, 230 for securing the pavement marking 100, 200 to a substrate, like a roadway or sidewalk. The adhesive may be a hot melt adhesive or may be a pressure sensitive adhesive. An optional release liner (not shown) may be included to protect the exposed surface of the adhesive before the pavement marking 100, 200 is applied to the substrate.

In one embodiment, the binder layer 110 itself is used to secure the pavement marking 100 to a substrate, like a roadway or sidewalk. For example, the binder layer 110 may be a thermoplastic material that is heated up to partially melt the material, securing the pavement marking 100 to the substrate.

Infrared-reflecting pigments in the described dark-colored retroreflective pavement markings are used to impart color in the visible spectrum as well as enable retroreflection from the retroreflective elements. As explained above, infrared-reflecting pigments will cause most of light in the infrared spectrum to reflect, with small absorption and/or transmission. In one aspect, the infrared-reflecting pigments act as a reflector layer for the retroreflective elements, and light impinging on the retroreflective elements is at least partially retroreflected toward the direction of the light source.

In some embodiments, the infrared-reflecting pigment has an average particle size of about 1 micron. In some embodiments, the infrared reflecting pigment has an average particle size of between 0.5 and 2.0 microns. In other embodiments, the average particle size is between about 0.3 and 5.0 microns. In some embodiments, the infrared reflecting pigment has an average particles size greater than 1 micron. Surprisingly, even though the infrared-reflecting pigment had a relatively large average particle size, larger than wavelengths in the ultraviolet, visible and near infrared spectra, the infrared-reflecting pigment did not negatively impact retroreflectivity of the pavement marking in these wavelengths. As a result, the dark-colored retroreflective pavement markings have a luminance factor Y of less than 15 while maintaining a retroreflective luminance (R_{L}) of at least 200 mcd/lux.m². In some embodiments, retroreflective luminance (R_{L}) is at least 300 mcd/lux.m². In some embodiments, retroreflective luminance (R_{L}) is at least 400 mcd/lux.m².

Examples of commercially available infrared-reflecting pigments include those available from Clariant (Charlotte, N.C.) under the trade designation COLANYL, from Heubach-Heucotech (Fairless Hills, Pa.) under the trade designation HEUCODUR, and from Ferro (Mayfield Heights, Ohio) under the trade designations COOL COLOR and ECLIPSE.

The infrared-reflecting pigment imparts a dark color and/or matte appearance to the dark-colored retroreflective pavement markings 100, 200 rendering them inconspicuous and/or unobtrusive to a human driver. This dark color/matte appearance, however, does not interfere with a sensor's ability to detect the dark-colored retroreflective pavement markings. In some embodiments, the dark-colored retroreflective pavement markings are disposed on the substrate (e.g., roadway) adjacent to white (or other light-colored) pavement markings. The dark-colored retroreflective pavement markings provide improved contrast to the adjacent white pavement markings, making its detection by autonomous vehicles easier.

Dark-colored retroreflective pavement markings 100, 200 further comprise retroreflective elements 120, 220. Such retroreflective elements 120, 220 are commonly used to make dark-colored retroreflective pavement markings 100, 200 more visually apparent in nighttime conditions. The retroreflective elements 120, 220 are designed to return light to the vicinity of the originating light source. Selection of the retroreflective elements 120, 220 can also make the dark-colored retroreflective pavement markings 100, 200 more apparent in nighttime and wet conditions. Any commonly used retroreflective elements 120, 220 can be used with dark-colored retroreflective pavement markings 100, 200. In one embodiment, the retroreflective elements 120, 220 are glass or ceramic beads. In one embodiment, the retroreflective elements 120, 220 are glass or ceramic beads with a refractive index of between 1.75 and 2.45. In one embodiment, the retroreflective elements 120, 220 are glass or ceramic beads with a 1.9 refractive index prepared as described in U.S. Pat. No. 6,245,700, the disclosure of which is herein incorporated by reference. In one embodiment, the retroreflective elements 120, 220 are glass or ceramic beads with a 2.45 refractive index prepared as described in U.S. Pat. No. 7,513,941, the disclosure of which is herein incorporated by reference. In one embodiment, the retroreflective elements 120, 220 are a combination of 50:50 (by weight) of the 1.9 index retroreflective elements and 2.45 index retroreflective elements. Elements disclosed in, for example, U.S. Pat. Nos. 6,245,700; 7,513,941; 8,591,044; 8,591,045 are suitable for use with dark-colored retroreflective pavement markings 100, 200. The disclosures of U.S. Pat. Nos. 6,245,700; 7,513,941; 8,591,044; 8,591,045 are incorporated herein by reference in their entireties. In one embodiment, the beads comprise one or more concentric coatings, as described in, for example, U.S. Pat. No. 8,496,340 incorporated herein by reference in its entirety.

One measure of daytime luminance of a surface is luminance factor Y, as defined in the CIE xyY color space, which is derived from the CIE 1931 XYZ color space created by the International Commission on Illumination (CIE). Values for x and y describe the chromaticity of the surface. A perfectly black surface that absorbs all light will have a value of luminance factor Y of zero, and a perfectly white surface that reflects all light from a uniform spectrum source will have a value of luminance factor Y of one hundred. Real surfaces fall between these limits. To improve differentiation of a dark-colored retroreflective pavement marking from surrounding light-colored substrates or pavement markings, it is desirable that the dark-colored retroreflective pavement marking have a lower luminance factor Y value.

Dark-colored retroreflective pavement markings 100, 200 having binder layers 110, 210 comprising the infrared-reflecting pigment and retroreflective elements 120, 220 have a luminance factor Y, a measure of luminance, of less than 20. In one embodiment, the disclosed dark-colored retroreflective pavement marking has a luminance factor Y of at less than 15. In one embodiment, the disclosed dark-colored retroreflective pavement marking has a Y of less than 10.

Another relevant measure of daytime “brightness” of the surface is the luminance factor for diffuse illumination, Qd, which is defined by ASTM E2302-03A and IS EN 1436 European Standard for Road Markings. The surface is illuminated with diffuse light, and then the reflected light is measured at an observation angle of 2.29 degrees to simulate a 30-meter viewing distance from a vehicle. To improve differentiation of a dark-colored retroreflective pavement marking from surrounding light-colored substrates or contrasting pavement markings, it is desirable that the pavement marking have a lower Qd value. In some embodiments, the dark-colored pavement markings have a Qd, a measure of luminance, of less than 90 mcd·m-2·lx-1. In one embodiment, the disclosed dark-colored retroreflective pavement marking has a Qd of less than 80 mcd·m-2·lx-1.

The disclosed dark-colored retroreflective pavement marking is retroreflective while having low luminance factor Y and Qd values via incorporation of infrared-reflecting pigments into a binder layer in which retroreflective elements are partially embedded. As a result of the low luminance factor Y and Qd values, the dark-colored retroreflective pavement marking has improved contrast when disposed adjacent a second pavement marking having a different, lighter color. The improved contrast renders the pavement markings more readily apparent to a sensor and/or in the output of a sensor (e.g., cameras, Lidar, etc.).

The disclosed dark-colored retroreflective pavement markings have adequate retroreflectivity, as measured by the coefficient of retroreflected luminance, R_{L}, measured in mcd.lux/m². In one embodiment, the dark-colored pigments have a R_{L} of at least 150 mcd.lux/m². In other embodiments, R_{L} is at least 200 mcd.lux/m², or at least 300 mcd.lux/m².

Additional materials, such as pigments and fillers, may be incorporated into the binder, such as, for example, skid-resistant particles.

In one embodiment, a sensor on a vehicle is used to detect contrasting pavement markings, as described in co-pending U.S. Provisional Application No. 62/471,764 (Attorney Docket No. 79386US002). Such sensors may include at least one of a camera, a LiDAR (light imaging, detection and ranging) system, or both. In one embodiment, the sensor identifies the pavement marking by comparison of the contrast of the pavement marking against the substrate. In one embodiment, the sensor identifies the pavement marking by a measure of retroreflectivity of the pavement marking.

FIG. 3 shows a top view of one embodiment of a pavement marking system 300. The pavement marking system 300 comprises a sensor 370 placed on a vehicle 364 and at least a first pavement marking 310 and a second pavement marking 320. Each of the first and second pavement markings 310, 320 comprise contrasting portions.

In this embodiment, the first pavement marking 310 extends longitudinally along the direction the vehicle travels and comprises a first portion 312 extending along a first longitudinal side 313 of the pavement marking 310, and a second portion 314 extending along a second longitudinal side 315 of the pavement marking 310. The first portion 312 includes a first property and the second portion 314 includes a second property, different from the first property. The first portion 312 of the first pavement marking 310 relative to the second portion 314 of the first pavement marking 310 provides a first signal to the sensor 370. Specifically, the difference in properties between the first portion and second portion provides the first signal.

The second pavement marking 320 extends longitudinally along the direction the vehicle travels and comprises a first portion 322 extending along a first longitudinal side 323 of the pavement marking 320, and a second portion 324 extending along a second longitudinal side 325 of the pavement marking 320. The first portion 322 includes a first property and the second portion 324 includes a second property, different from the first property. The first portion 322 of the first pavement marking 320 relative to the second portion 324 of the first pavement marking 320 provides a second signal to the sensor 370. The arrangement of the first signal relative to the second signal correspond to a defined lane. Specifically, the difference in properties of the first portion and second portion provides the first signal.

In one embodiment, the first property and the second property are one of color (as measured by, for example, luminance factor Y or Qd), wavelength, or retroreflectivity. In one embodiment, the dark-colored pavement marking has a first color, or first luminance factor Y and the second pavement marking has a second color, or second luminance factor Y.

In one embodiment, the first signal and second signal can be read by the sensor 370 as a pattern of difference in luminance in a horizontal trace of pixel intensities in the collected image data at some range of wavelengths. For example, this pattern might be a result of a difference in color or a difference in retroreflectivity. As shown in FIG. 3, the first and second pavement makings each include first and second portions of different properties. In one embodiment, the property is color. Specifically, the different colors are black (or dark-colored) and white.

For the first pavement marking 310, the first portion 312 of the first pavement marking 310 is black or dark-colored and the second portion 314 of the first pavement marking 310 is white or light-colored. The relative placement of black relative to white will provide to the sensor 370 a first signal. In this embodiment, black is on the left and white is on the right and the first signal is interpreted as a “1”.

For the second pavement marking 320, the first portion 322 of the first pavement marking 320 is white and the second portion 324 of the first pavement marking 320 is black. The relative placement of black relative to white will provide to the sensor 370 a second signal. In this embodiment, black is on the right and white is on the left and the second signal is interpreted as a “2”.

The sensor sees the arrangement of the first signal, as “1” on the right side of the sensor in this embodiment, and the second signal, a “2” on the left side of the sensor, and therefore assigns the car to the second lane to the right side of the pavement edge.

It is understood from FIG. 3 that interchanging location of the first portion and second portions of the pavement marking tape will result in further signals that are either a “1” or a “2.” Therefore, as shown in FIG. 3, reading from left to right a 1-1 read is lane 5, a 1-2 read is lane 4, a 2-2 read is lane 3, and as described above the 2-1 read is lane 2. It is understood the continuously extending furthest pavement marking relative to the discontinuous pavement marking will indicate lane 1 and lane 6, respectively.

The pavement marking may be any construction to provide the contrast needed to distinguish the first portion from the second portion (and third portion, if included). For example, the pavement marking may have contrasting colors or differing levels of retroreflectivity. The pavement marking may be painted, may be a tape, or may include a portion that is painted on the roadway and a portion that is tape. The pavement marking may include retroreflective element to control the retroreflectivity at one or both portions of the pavement marking (or the third portion, if included).

For ease of installation, in one embodiment, the pavement marking comprises a single substrate that is a tape to be adhesively secured to a roadway.

The sensor 370 is able to read the pavement marking image. For example, the sensor may be a camera or use Lidar. The sensor may further include a processor, or may work with a processor to interpret the information received.

In one embodiment, methods and systems for detecting lane position within a roadway are disclosed. The disclosed method relies on detection and identification of differentiating features extracted from a signal. It is not particularly relevant in which way such differentiating features are extracted and there is a plurality of ways known from the state of the art. For further explanation, a method similar to that described in U.S. Pat. No. 4,970,653 (Kenue) may be used. In the method of Kenue, a vehicle is mounted with at least one camera for viewing a scene ahead of the vehicle. The camera is used to generate a digital image of the scene (output) and further processing steps include normalizing the image, defining a search area in the image, and searching lane markers (pavement markings) in the search area of the image. In one embodiment, the dark-colored retroreflective pavement markings comprise a first portion and a second portion, wherein the first portion of the first pavement marking relative to the second portion of the first pavement marking provides a first signal which is detected on the output of the sensor. In one exemplary method, after detection of the pavement marking from the search area of the image is accomplished, the system further detects the signal provided by the first and second portions of the pavement marking. In some embodiments, detection of the signal is successful when above a predetermined threshold. The system then uses information provided by the signal to determine lane position.

In some embodiments, the first portion of the pavement marking has a first feature and the second portion has a second feature, different from the first feature. In some embodiments, the first feature is a first color and the second feature is a second color. In some embodiments, the first color is black and the second color is white. The differentiating features are detected either by the sensor or on the output of the sensor and the signal provided by the first portion relative to the second portion relates to increased contrast of the detected pavement marking on the image captured by the camera.

In yet another exemplary embodiment, the first feature and the second feature are retroreflectivity or brightness. In some embodiments, the first portion has lower retroreflectivity (Ra) than the second portion. This change in retroreflectivity results in increased contrast on the captured image.

Other exemplary methods to extract differentiating features from the output of a sensor are described in U.S. Pat. No. 9,081,385 (Ferguson et al.), and U.S. Pat. No. 8,462,988 (Boon), both incorporated herein by reference in their entireties.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

### EXAMPLES

MATERIALS

| Trade Designation | Description | Manufacturer |
|---|---|---|
| CAPA 3031 | Low molecular weight trifunctional | Perstorp, Malmo, |
| | caprolactone polyol in which all of the | Sweden |
| | hydroxyl groups are primary. It has a | |
| | molecular weight of 300 and a typical OH | |
| | value of 560 mg KOH/g. | |
| Methyl ethyl ketone | | |
| Acetone | | |
| DESMODUR N100 | Solvent-free, aliphatic polyisocyanate resin | Covestro, |
| | based on hexamethylene diisocyanate (HDI), | Pittsburgh, PA |
| | with an equivalent weight of 191. | |
| BLACK FERRO 10202 | IR-reflecting pigment with a black appearance | Ferro, Mayfield |
| ECLIPSE BLACK | and a mean particle diameter size of 1.03 | Heights, OH |
| PIGMENT | microns. | |
| LUMIFLON LF916F | Fluoroethylene vinyl ether polyol having an | Asahi Glass |
| | average molecular weight of 7,000, and | Company |
| | hydroxy value of 98 mgKOH/g. | |
| ZAS 1.9 Refractive Index | 1.9 zirconia-alumina-silicate elements prepared as described in U.S. | |
| Retroreflective Elements | Pat. No. 4,931,414 | |
| BLACK EMBOSSED | Prepared as described in Example 14 of U.S. Pat. No. 6,468,678. | |
| MAGNETIC BACKING | | |
| BLACK EMBOSSED | Obtained from 3M STAMARK HIGH | 3M Company |
| RUBBER BACKING | PERFORMANCE TAPE SERIES 385IES | |
| IRIODIN 9119 POLAR | Pearlescent pigment including mica coated | Merck KGaA, |
| WHITE | with titanium dioxide and tin oxide. | Darmstadt, Germany |
| 3M SCOTCHLITE | Black opaque ink | 3M Company |
| TRANSPARENT SCREEN | | |
| PRINTING INK SERIES 905 | | |

Test Methods

Luminance, Y, as defined in the CIE xyY color space: luminance factor Y was measured for flat samples according to ASTM D6628-03 on a Hunterlab Labscan 2 colorimeter (available from Hunter Associates Laboratory, Reston, Va.) with a 45°:0° illuminating and viewing geometry.

Luminance Coefficient under Diffuse Illumination, Qd: Qd was measured for embossed samples according to ASTM E2302-03a and the IS EN 1436 European Standard for Road Markings on a LTL-XL reflectometer made by Delta from (Horsholm, Denmark) at an observation angle of 2.29 degrees to simulate a 30m viewing distance.

Retroreflected Luminance, R_{L}: the coefficient of retroreflected luminance, R_{L}, was measured under dry conditions in accordance with the procedure generally outlined in ASTM E1710-11, “Standard Test Method for Measurement of Retroreflective Pavement Marking Materials with CEN-Prescribed Geometry Using a Portable Retroreflectometer”.

### Comparative Example A

Comparative pavement marking of Comparative Example A was prepared as follows: a binder composition was prepared by combining 51.4 pph of CAPA 3031 polyol diluted to 68% solids with a 50:50 mixture of acetone and methyl ethyl ketone, and 48.6 pph DESMODUR N100. The mixture was homogenized.

Comparative Example A included a BLACK EMBOSSED RUBBER BACKING onto which the binder was coated, following the procedure generally described in U.S. Pat. No. 4,988,541, incorporated herein by reference in its entirety. ZAS 1.9 Refractive Index Retroreflective Elements were coated onto the binder and the pavement marking was dried in an oven at a temperature of about 110° C. for about 30 minutes.

### Example 1

Dark-colored retroreflective pavement marking of Example 1 was prepared as described in Comparative Example A above, except that a black infrared-reflecting pigment was added to the diluted CAPA 3031 composition prior to the addition of DESMODUR N100. About 23.6 pph (parts per hundred) of infrared-reflecting pigment were added to about 39.3 pph of the polyol composition. Subsequently, 37.1 pph of polyisocyanate were added to the polyol/pigment premix and homogenized. Final pigment content of the binder of Example 1 was 23.6 wt % based on the total weight of the binder composition.

### Example 2

Dark-colored retroreflective pavement marking of Example 2 was prepared as described in Example 1, above, except that (i) the CAPA 3031 polyol was replaced with LUMIFLON LF916F, (ii) the polyol was diluted to 50% solids with the mixture of acetone and methyl ethyl ketone, and (iii) a black embossed magnetic backing was used. About 70.5 pph of diluted LUMIFLON LF916F were mixed with about 17.5 pph of BLACK FERRO 10202 ECLIPSE and subsequently mixed with 12 pph of polyisocyanate and homogenized.

Samples of Examples 1-2 and Comparative Example A were inspected and measured for retroreflected luminance (R_{L}), daytime luminance (luminance factor Y) and luminance factor Qd using the test methods described above. Respective average test results are reported in Table 1, below.

TABLE 1

| | Retroreflected | Daytime | |
|---|---|---|---|
| | luminance, R_{L} | Luminance, | Qd |
| Examples | (mcd/lux/m²) | luminance factor Y | (mcd/lux/m²) |
| Comparative | 54 | 7.8 | 119 |
| Example A | | | |
| Example 1 | 466 | 6.2 | 68 |
| Example 2 | 476 | 5.9 | 32 |

Those having skill in the art will appreciate that many changes may be made to the details of the above-described embodiments and implementations without departing from the underlying principles thereof. The scope of the present disclosure should, therefore, be determined only by the following claims.

1. A dark-colored retroreflective pavement marking comprising:
a binder layer;
an infrared-reflecting black pigment; and
a plurality of retroreflective elements distributed on at least a portion of the binder layer.

2. The dark-colored retroreflective pavement marking of claim 1, wherein the binder layer is a polyurethane.

3. The dark-colored retroreflective pavement marking of claim 1, wherein the pavement marking has a luminance factor Y of less than 10.

4. The dark-colored retroreflective pavement marking of claim 1, wherein the pavement marking has a Qd of less than 80 mcd·m-2·lx-1.

5. (canceled)

6. The dark-colored retroreflective pavement marking of claim 1, wherein the retroreflective elements comprise glass or ceramic beads.

7. (canceled)

8. The dark-colored retroreflective pavement marking of claim 1, further comprising an adhesive.

9. The dark-colored retroreflective pavement marking of claim 8, wherein the retroreflective elements are on a first major surface of the binder layer and the adhesive is on a second major surface of the binder layer.

10. (canceled)

11. The dark-colored retroreflective pavement marking of claim 1, further comprising an additional backing that is at least one of an embossed backing, a rubber backing or a thermoplastic backing.

12. (canceled)

13. (canceled)

14. The dark-colored retroreflective pavement marking of claim 1, wherein the infrared-reflecting pigment is added in an amount ranging between 10 and 40 weight percent based on the total weight of the binder composition.

15. The dark-colored retroreflective pavement marking of claim 1, further comprising:
a second pavement marking adjacent to the dark-colored retroreflective pavement marking;
wherein the dark-colored retroreflective pavement marking has a first property and the second pavement marking has a second property; and
wherein the second property is different from the first property.

16. The dark-colored retroreflective pavement marking of claim 15, wherein the dark-colored retroreflective pavement marking is immediately adjacent the second pavement marking.

17. The dark-colored retroreflective pavement marking of claim 15, further comprising an intervening area between the dark-colored retroreflective pavement marking and the second pavement marking.

18. (canceled)

19. (canceled)

20. A system for identifying a pavement marking comprising:
a sensor;
a dark-colored retroreflective pavement marking comprising a binder layer and an infrared-reflecting black pigment; and
retroreflective elements distributed on at least a portion of the binder layer;
wherein the sensor detects and identifies the pavement marking by comparison of the contrast of the dark-colored retroreflective pavement marking against the substrate.

21. The system of claim 20, wherein the sensor identifies the dark-colored retroreflective pavement marking by a measure of luminance of the dark-colored retroreflective pavement marking.

22. A pavement marking system comprising:
a first pavement marking comprising a binder including a black infrared-reflecting pigment, wherein the first pavement marking has a first property;
a second pavement marking comprising a binder having a second property, different from the first property, the second pavement marking being adjacent the first pavement marking;
a sensor that detects a difference between the first property and the second property and generates a signal;
a processing unit that processes the signal and provides an output to a vehicle.

23. The pavement marking system of claim 22, wherein the output is one of a defined lane and a machine-readable code.

24. The pavement marking system of claim 22, wherein the sensor is one of a camera or includes LiDAR.

25. The pavement marking system of claim 22, wherein the first pavement marking extends longitudinally along the second pavement marking, and wherein the first pavement marking and second pavement marking are disposed longitudinally along a road surface to which they are applied.

26. The pavement marking system of claim 22, wherein the first property and the second property are one of color, wavelength, or retroreflectivity.

27. (canceled)

28. The pavement marking system of claim 22, further comprising a third pavement marking having a third property, wherein the third property may be one of (i) the same as the first property of the first pavement marking, (ii) the same as the second property of the first pavement marking, or (iii) different from both the first and second properties of the first pavement marking.

29. (canceled)
